(19) United States
(12) Patent Application Publication
(10) Pub. No.: US 2016/0092556 A1
(43) Pub. Date: Mar. 31, 2016

(54) GENERATION OF DATA FOR A DENDROGRAMMATIC TREE DATA STRUCTURE

(71) Applicant: Apple Inc., Cupertino, CA (US)

(72) Inventors: Edwin R. Cooper, Cupertino, CA (US); Nicholas A. Tucey, Los Gatos, CA (US); Peter Leong, Mountain View, CA (US)

(21) Appl. No.: 14/502,291

(22) Filed: Sep. 30, 2014

(51) Int. Cl. G06F 17/30

(52) U.S. Cl. CPC G06F 17/30622; G06F 17/30244; G06F 17/30755; G06F 17/30823; G06F 17/30722

(57) ABSTRACT

Methods and systems which can be used to create data for one or more nodes of a tree data structure by searching through another data structure containing, for example, metadata that describes digital assets such as apps (applications) available through an app store.

### BACKGROUND

It is often desirable to group items into categories so that a user of a data processing system (e.g. a computer) can search for items by searching in a particular category which should contain items of interest to the user. For example, documents stored in a computer system can be categorized into groups or categories based on their content. Documents about sports can be placed in a sports category while documents about food can be placed into a food category. One way to implement this categorization in a computer system is to use a dendrogram which is a tree like data structure that has a hierarchy; the hierarchy includes a root node at the top that has no parent node and can be considered a hypothetical node (in that it may not contain any documents and may not be assigned a category). Under the root node, there can be layers of nodes, with each node typically containing one or more documents relevant to the particular node and reflective of that node's position within the dendrogram's hierarchy % A node typically has a label that describes the documents contained in the node. The dendrogram is created and the nodes are populated with documents associated with particular nodes, and then a user can search for documents within the populated nodes.

### SUMMARY OF THE DESCRIPTION

The various embodiments described herein can be used to create data for one or more nodes of a tree data structure by searching through another data structure containing, for example, metadata that describes digital assets such as apps (executable computer program applications) which can be made available through an app store. A method according to one embodiment can include operations such as storing a representation of nodes in a dendrogram data structure and creating data for one of the nodes by performing a search through a data structure of a set of documents or other items such as the metadata of the documents which can describe items in categories represented by the nodes.

One embodiment of a method described herein can include the following operations: storing a representation of nodes in a dendrogram tree data structure, the nodes representing categories of items; receiving a user's selection that specifies one of the nodes in the dendrogram tree data structure; constructing a search query based on the specified node, the search query being specific for the specified node relative to other search queries for other nodes in the dendrogram tree data structure; searching through a data structure, which contains metadata of the items in the categories, using the search query to generate a list of items matching the search query for the specified node; and transmitting at least a portion of the list of items to the user. A method according to one embodiment can further include the following operations: creating ranking criteria for the specified node, the ranking criteria being different for the specified node relative to ranking criteria for other nodes in the dendrogram tree data structure; ranking the list of items using the ranking criteria to generate a rank list of items; and transmitting a ranked list of items to the user. In one embodiment, the items which are categorized using the tree data structure can include apps (such as executable computer program applications) stored in an app store, and the data structure which is searched using the search query for a specific node can include an inverted index database containing the metadata of the apps stored in the app store, such as metadata of all apps stored in the app store. In one embodiment, the search query can be constructed and cached before receiving the user's selection that specifies one of the nodes; in another embodiment, the search query can be constructed in response to receiving the user's selection that specifies one of the nodes (in other words the search query is constructed after receiving the user's selection that specifies one of the nodes). In one embodiment, the searching through the data structure can be performed after the user's selection and is therefore in response to the user's selection.

In one embodiment, the dendrogram tree data structure has a single root node with no parent nodes and has multiple nodes that each have a single parent node and multiple child nodes. In one embodiment, the items which have been categorized into the categories can include digital media stored in a media store, and this digital media can include one or more of: songs; movies; photos; TV shows; magazines; or books. Moreover, the data structure relating to this digital media can include an index containing the metadata of the digital media (for example the metadata can include song names, artist names, album titles, genre information, etc.). In one embodiment, the dendrogram tree data structure can be updated dynamically in order to change or add or remove categories; the updating of the tree data structure can be performed dynamically because the search queries can be constructed for a specific node after updating the tree data structure and the search queries can be generated dynamically in response to user searches or selections of particular categories or sub-categories. In one embodiment, the search query can include a category of the specific node which is conjoined with (e.g. through an AND logical operator) with a category of each ancestor node up toward the root of the dendrogram tree data structure.

In one embodiment, the ranking criteria for a node can vary based upon the position of the node in the tree data structure. For example, the ranking criteria for a node near the root of the dendrogram tree data structure can include an authority signal that is weighted more heavily than a weighted authority signal in the ranking criteria for a node that is near the bottom of the tree (and therefore is not near the root of the tree). In one embodiment the authority signal can include one or more of: user ranking scores; popularity scores; or data representing user interactions with items within a particular category or groups of categories. The weights which are applied in the process of ranking the search results can also be varied upon whether a hit was found in the title of the digital asset (such as an app) rather than in the description of the digital asset which is also a form of metadata for the digital asset.

Systems which perform the methods described herein and non-transitory machine readable storage media which store executable computer program instructions to cause a data processing system to perform the one or more methods described herein are also presented in this disclosure.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

This disclosure is illustrated by way of example and not limitation in the figures of the accompanying drawings in which like references indicate similar elements.

FIG. 1 is a flowchart showing an example of a method according to one embodiment described herein.

FIG. 2A shows an example of a generic tree data structure which can be used in one or more of the embodiments described herein.

FIG. 2B shows an example of a specific tree data structure according to one embodiment described herein.

FIG. 3 is a flowchart which illustrates a method according to one embodiment described herein for generating a searchable data structure which is searched by search queries generated from one or more nodes of a tree data structure.

FIG. 4 shows an example of a searchable data structure according to one embodiment described herein.

FIG. 5 is a flowchart which illustrates a method according to one embodiment described herein.

FIG. 6 shows an example of a constructed search query which is constructed from a node selected from a tree data structure.

FIG. 7A shows an example of a tree data structure and how different ranking criteria can be used at different levels of the tree data structure.

FIG. 7B shows an example of a data source, such as a data structure or database for storing one or more authority signals which can be used when ranking search results according to one or more embodiments described herein.

FIG. 8 shows an example of a system which can employ one or more server devices which communicate with one or more client devices through a network.

FIG. 9 is a block diagram illustration of an example of a data processing system which can be used to implement one or more embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

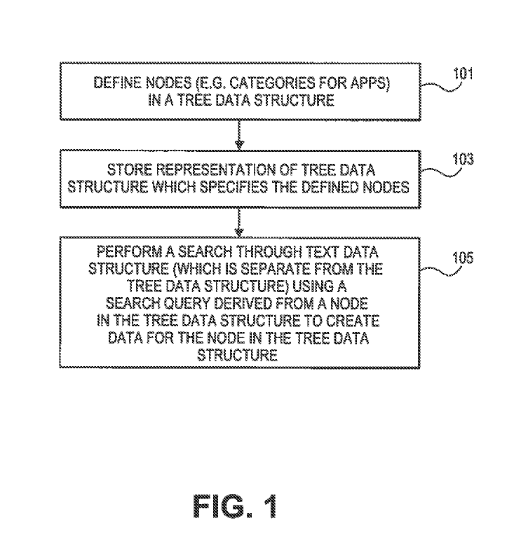

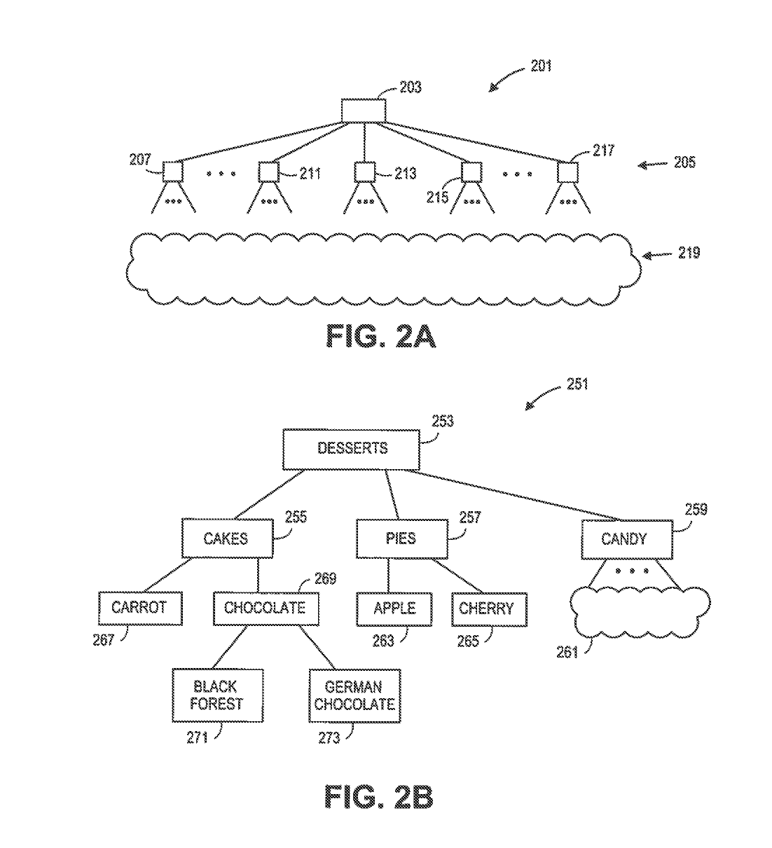

One aspect of this disclosure relates to a method for generating data for one or more nodes in a tree data structure, such as a dendrogram by performing a search through a data structure of a set of “documents”, wherein the search is through metadata in the documents, and the metadata describes items in categories represented by the nodes. A general method according to one embodiment is shown in FIG. 1, and this method can begin in operation 101 in which the nodes of a tree data structure are defined. In one embodiment these nodes can represent categories for digital assets such as apps (executable computer programs) which can be made available for downloading from an app store or other facility. In one embodiment, each node can represent or be labeled by a particular category in a set of possible categories. A particular category can be considered a sub-category of a parent category as will be described further herein. In operation 103, the representation of the tree data structure can be stored in a memory of a data processing system, and this representation in effect specifies each of the defined nodes in the tree data structure. FIGS. 2A and 2B provide two examples of tree data structures which will be described further below. In operation 105, the data processing system can then perform a search for text in a text data structure, which is separate from the tree data structure, using a search query which is derived from a particular node in the tree data structure to create data for the node in the tree data structure. In one embodiment, the text data structure can be a full text indexed database which stores text metadata relating to all of the apps or other digital assets in an app store or media store. The search query which is used to search through the text data structure can be generated based upon a selected node which is either selected by a user at search time when a user is looking for a particular app to buy or download, or at the time when an app store developer or operator is attempting to generate a list of apps for each node in the tree data structure.

Rather than populating the items, such as apps, within a dendrogram node statically at the time of the dendrogram creation, the method of at least certain embodiments described herein allows an app store or digital asset store operator to populate items within each node by constructing a search query specific to that node and by dynamically refreshing the result set of that search query in order to maintain a dynamic, ordered list of items for a particular node at the time of the search. This approach to populating dendrogram nodes with the results of a search query allows for the population of a particular node over a dynamically changing corpus of apps or other digital assets over time. For example, if apps are routinely added or removed or updated each day in an app store or a digital asset store, it allows an app store operator to dynamically generate an ordered list of apps or digital assets within a particular category or node through a search process described herein. In other words, apps or other digital assets could be added to the corpus at any time without having to worry about creating an updated list of apps for each node in the app store. This approach also allows for considerable flexibility in using existing state of the art search technology to tune the search results to match expected users' needs. For example, certain dendrogram applications may prefer search results in each node which favor apps rated higher by authoritative signals whereas other uses might prefer apps which are highly textually relevant to each node.

FIG. 2A shows an example of a generic tree data structure 201 which includes a root node 203 and a layer 205 of nodes which includes nodes 207, 211, 213, 215 and 217. The tree data structure 201 also includes one or more further layers of nodes 219. The root node 203 may have no label and each of the other nodes may include a label which indicates the category of the node. For example, in layer 205, the node 207 may have a label of sports and the node 211 may have a label of food, and the node 213 may have a label of music, and the node 215 may have a label of travel, etc. Each label designates a category for that node and each of these nodes can have one or more child nodes relating to sub-categories within the parent category. For example, if node 207 has a label for sports, some of the child nodes of node 207 can include labels for specific types of sports, such as baseball, football, lacrosse, basketball, etc. Similarly, if node 211 is a food category, then child nodes under node 211 can include categories such as desserts, salads, etc. In one embodiment, the tree data structure 201 can represent the categories of apps ire app store; these categories can include categories such as productivity, games, news, weather, travel, sports, reference, medical, education, entertainment, music, health and fitness, finance, etc. Each of these categories may include sub-categories and each of the sub-categories may further include one or more sub-categories, and the tree data structure defines the relationship between the categories and sub-categories.

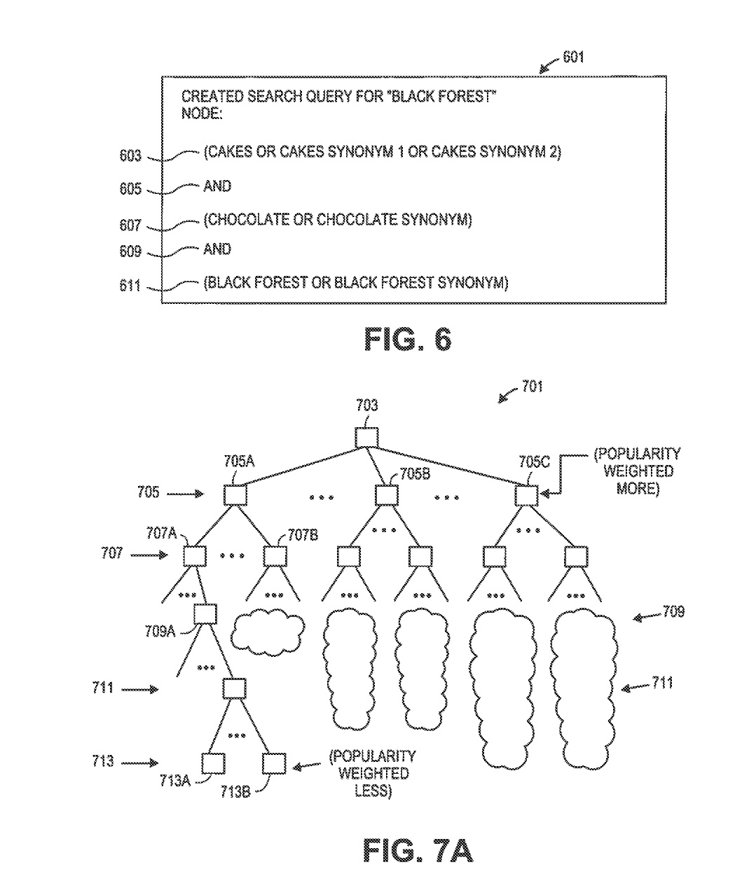

FIG. 2B shows a specific example of a tree data structure 251. In this case, the root node 253 includes a label “desserts”, and there are three main categories below the root node. In particular, node 255 is for the category cakes, node 257 is for the category pies, and node 259 is for the category candy. Each of these nodes 255, 257 and 259 have one or more child nodes which represent sub-categories within the particular category. For example, node 255 has two child nodes 267 and 269 for the two categories of cake known as carrot cake and chocolate cake. The node 269 has two children nodes 271 and 273 for two different types of chocolate cakes, in this case a black forest cake and the German chocolate cake which is assigned to node 273. The pies category or node 257 includes two children nodes representing two sub-categories of pies. In particular, node 263 is for apple pies and node 265 is for cherry pies. The candy node 259 can have one or more children nodes each of which can have one or more children nodes represented by layers 261 shown in FIG. 2B. The labels for each of the nodes can be used as described further below to create specific search queries for each node which can then be used to perform the search through a text data structure as described in conjunction with operation 105 shown in FIG. 1. Further details with respect to the creation of a search query for a particular node will be described further below, including a description associated with FIG. 6. This description will now turn to a discussion of the text data structure which is searched through using the search query generated from a particular node.

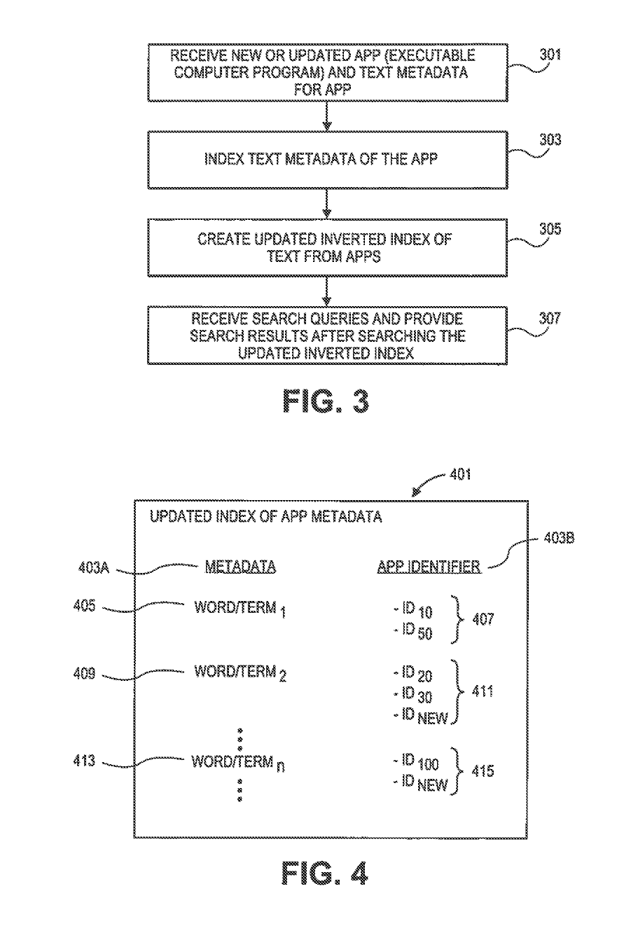

FIG. 3 shows a method for generating a text data structure which can be searched in order to populate the items, such as a list of apps, within a particular node of a tree data structure. In one embodiment, this text data structure can be text metadata associated with each app for all of the apps in an app store. This text metadata can be provided by the developer of the app or by users of the app or by the app store operator or by a combination of these participants. The text metadata can include a list of categories that an app is considered to be part of and can also include text descriptions of the app and other text, such as text from users, user feedback, etc. It will be appreciated that this text is not part of the content of the app, as the content of the app is executable software code and this context is normally not indexed into a searchable text database but rather only the supplied metadata is indexed as described herein. Referring now to FIG. 3, the method shown in FIG. 3 can begin in operation 301 in which a new or updated app, which is an executable computer program, is received along with the text metadata for that app. In one embodiment, the text metadata can be created by the app developer and provided to an app store operator who can then perform operations shown in FIG. 3 to create an updated text data structure which can be searched. An updated app can include both an updated executable computer program and also be provided with updated text metadata such as modified text (in, for example, a description of the changes to the app or a description of the app, etc.) and/or modified list of categories of the updated app. Following the receipt of the new or updated app and the text metadata associated with the app, operation 303 can be performed in which the text metadata of the app is indexed into an index database which in one embodiment can be an inverted index of the full text (without stop words) of all of the text metadata from all of the apps in the app store. The result of operation 303 produces an updated inverted index in one embodiment in which operation 305 creates the updated inverted index of the text from all of the apps in the app store.

FIG. 4 shows an example of a text data structure which can be searched using the search query derived from a particular node in the tree data structure. In one embodiment, this text data structure can be an inverted index of app metadata created through operation 305. This text data structure shown in FIG. 4 will be described further below. In operation 307, the method can receive search queries from one or more users or from an app store operator in order to populate the nodes of the tree data structure and to provide search results representing the contents of a node after searching the updated inverted index, which is a form of a text data structure. In one embodiment, the search results can be all apps in a given or selected node, and these search results can be ranked or ordered based upon a ranking criteria which is further described below. Thus operation 307 can provide, in response to the search queries, a set of ranked search results representing a set of apps in a given or selected node based upon the search query which is generated for that particular node.

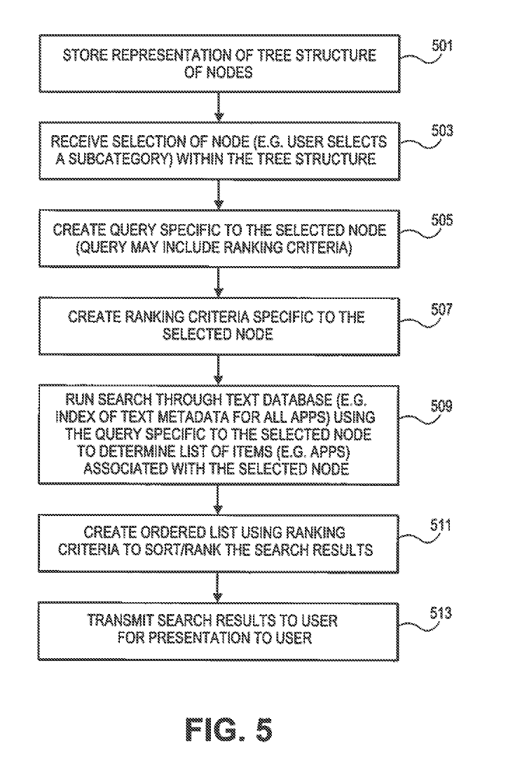

FIG. 4 shows an example of a text data structure 401 which can be searched according to one or more embodiments described herein to provide the search results, such as the search results provided through operation 307 of FIG. 3. The data structure 401 can be created using operations 301, 303 and 305 in FIG. 3 to create in this embodiment an updated inverted index of the text metadata from all apps in an app store. The data structure 401 is logically illustrated with two columns 403A and 403B, where column 403A represents the text metadata obtained from each of the apps and column 403B contains the app identifier associated with each app. The app identifiers can, in one embodiment, be a set of unique values assigned to apps by an app store operator, and each of these unique values maps uniquely to the name of the app so that the results of a search of data structure 401 can return the names of the apps (instead of returning the app identifiers which would normally be unrecognizable to users). For example, text metadata 405 represents a particular word such as “sports”, and the data structure 401 shows that that term or word occurs in the text metadata for two apps shown by their identifiers 407. In particular, the app with the identifier ID 10 and the app with the identifier ID 50 both include the text metadata 405, and the data structure 401 shows that association or relationship between the text metadata 405 and each of the app identifiers in the set of app identifiers 407 shown in FIG. 4. Similarly, three apps include the text metadata 409 which can be another word such as “food” and this word is found in the text metadata of three apps having app identifiers 411. One of those apps has an app identifier ID new as shown in FIG. 4 which is a new app which is received in operation 301 in the method of FIG. 3. Two other apps, shown as ID 20 and ID 30 also include that same word. Text metadata 413 is contained within the text metadata of two apps shown in the group of app identifiers 415, and one of these app identifiers is ID new. This text metadata 413 was received with the new app in operation 301 to create the updated index in operation 305. The data structure 401 does not include the executable code of any of the apps in the app store in one embodiment but rather includes only the text metadata provided with the app or otherwise generated for the app by either the app developer or the app store operator or by users or by a combination of such participants. In one embodiment, the inverted index data structure shown in FIG. 401 can be quickly searched in operation 307 to provide the search results based upon a given search query which was generated for a selected node. This description will now turn to an example of a specific embodiment which is represented by the flowchart of FIG. 5.

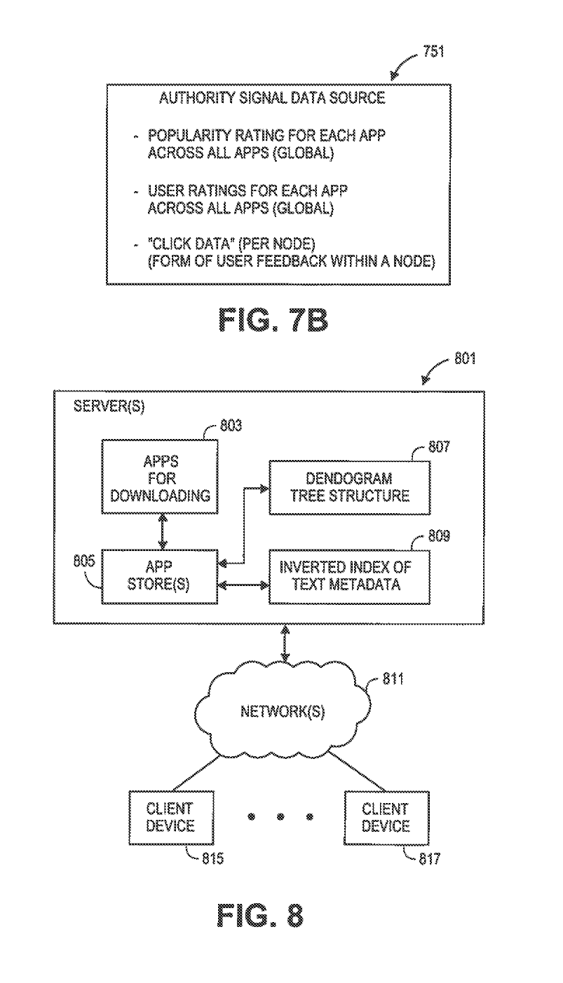

The method shown in FIG. 5 can use a tree data structure, such as the tree data structure 201 or the tree data structure 251 and can also use the text data structure, such as the text data structure 401, in the method shown in FIG. 5. In operation 501, the method can store a representation of a tree structure of the nodes, such as the tree data structure 201. In operation 503, the data processing system can receive a selection of a node within the tree structure. The selection of the node may occur in response to a user selecting a sub-category through a user interface presented on a client device, such as client device 815 or 817 shown in FIG. 8. In another embodiment, the selection of the node can be received in a pre-population operation in which an app store operator selects a set of nodes, such as all nodes, in order to create search queries for the sets of nodes in order to pre-populate the search queries for each node. In operation 505, the data processing system creates a query which is specific to the selected node which was selected in operation 503. FIG. 6 shows an example of a created search query based upon the selected node “black forest” which is node 271 in the tree data structure 251 shown in FIG. 2B. The method can continue in operation 507 in which ranking criteria which can be specific to the selected node can be created for the selected node. FIG. 7A, which will be described further below, provides an example of ranking criteria which can be made specific to a selected node or at least different relative to other nodes depending upon, for example, the level of the selected node within the entire tree data structure. In one embodiment, the ranking criteria can be included as part of the specific query in operation 505, while in other embodiments, the ranking criteria can be used after receiving search results in order to sort and rank the search results. In operation 509, the data processing system can then run a search through the text database, such as the text data structure 401 shown in FIG. 4 which includes all of the text metadata for all apps in an app store in one embodiment using the query which is specific to the selected node and which was derived in operation 505. This search through the text database will then determine a list of items, such as apps within an app store which are associated with the selected node. Then, in operation 511, the data processing system can create an ordered list using the ranking criteria to sort and rank the search results. These search results can then be transmitted in operation 513 to the user who selected the node so that the search results can be presented to the user. In one embodiment, the search results may display a ranked list of apps which are associated with a particular category or node in the tree structure of apps. In another embodiment, the list presented to the user can be a list of digital assets in a digital media store, such as songs, movies, photos, TV shows, magazines, books, etc.

In one embodiment of the method shown in FIG. 5, no app identifier data needs to be stored in the tree; only the tree's category structure needs to be stored and used when creating the search query. This allows for the tree data structure to be changed at any time or updated at any time to dynamically adjust the tree data structure by, for example, adding categories, removing categories, changing category labels, merging categories, splitting a category into two or more categories, etc. This can provide some flexibility to an app store operator to change the categories at any one point in time and thereby recreate the appropriate search query for each search category based upon the tree data structure. In one embodiment, operation 505 may be performed prior to any user's selection of a node by pre-calculating all of the search queries for each of the nodes in the tree data structure after the tree data structure is finalized. In one embodiment, the operations 509 and 511 can be performed at “search time” when a user has selected a particular category or node while in another embodiment the search can be performed to pre-populate the whole tree with app identifier data which can then be cached and used to provide search results.

FIG. 6 shows an example of how a search query is created for a specific node within a tree data structure. In this example, node 271 in the tree data structure 251 is used as the selected node which could be selected by a user in an operation, such as operation 503; alternatively, the selection can be performed in a pre-population operation in which the search queries for all of the nodes are created prior to any user's use of the nodes or categories. A data processing system creates a specific search query for a specific node by using the label for each node to create a search query with AND operators and OR operators. The AND operator creates conjoined search elements while the OR operator creates a disjunction of terms and is used with synonyms as shown in FIG. 6. An individual search query can be constructed for every node of the dendrogram, and each search query defines the set of apps or other digital assets which may appear at that node. A given dendrogram node, except the root node, has one or more ancestors, including its parent node, its grandparent, and other ancestors up to (and optionally include) the root node. The search query for a given node will be comprised of a set of conjoined search elements, one required element for each ancestor node. Each of these conjoined search elements may itself be a disjunction of terms or other search elements constructed so as to match the criteria of the node in question. For example, synonyms can be used for each label in each node as shown in FIG. 6. Search element 603 uses the label in node 255 and synonyms for that label, and search element 603 is conjoined with search element 607 and 611 through the AND operators 605 and 609. Search element 607 uses the label from node 269 and synonyms for that label to create the search element in 607, and the search element 611 includes the label from node 271 as well as synonyms for that label within search element 611. Thus, the label for the selected node as well as all ancestors are conjoined with AND operators to create the search query for a selected node. In one embodiment, the tree data structure 251 can represent a dendrogram which hierarchically categorizes a corpus of apps for desserts or which hierarchically categorizes a corpus of dessert recipes. In the example shown in FIG. 6, the search query does not include ranking criteria; in this implementation shown in FIG. 6, the ranking criteria can be applied after receiving search results in operation 509. In other words, the search results can be ranked in an operation performed after receiving the search results, such as operation 511 which ranks and sorts the search results which can ultimately be presented to the user. In another embodiment, the search query itself can include the ranking criteria which is described further below.

In one embodiment, the search query for a node can include negation terms to exclude certain items from the search results. These negation terms can be used in addition to the terms or labels derived from the node's position in the dendrogram tree structure. In one embodiment, each node in the tree structure (or a set of such nodes) can include negation terms to exclude certain items from a search result of items associated with the node. For example, referring to the search query shown in FIG. 6, a negation term of “cake walk” can be included (through an AND operator) in the search query shown in FIG. 6 to specifically exclude items containing the term “cake walk” (since such items are not really about cakes in the sense intended for this category/node). In this example, the search query of FIG. 6 would be modified to be: (cakes OR cakes synonym 1 OR cakes synonym 2) AND (chocolate OR chocolate synonym) AND (black forest OR black forest synonym) AND (NOT cake walk). A set of possible negation terms can be used with an OR operator to exclude multiple sets of items (for example, the modified search query of FIG. 6 can be (cakes OR cakes synonym 1 OR cakes synonym 2) AND (chocolate OR chocolate synonym) AND (black forest OR black forest synonym) AND (NOT cake walk OR NOT piece of cake)).

FIGS. 7A and 7B provide examples of ranking criteria which can be used to rank search results after obtaining the search results or which can be used within search queries themselves. FIG. 7A shows a tree data structure 701 which includes a root node 703 and at least four layers or levels 705, 707, 709, 711, and 713 of nodes. The first level 705 includes at least three nodes 705A, 705B and 705C. Level 707 includes nodes 707A and 707B, and level 709 includes node 707A. Nodes 713A and 713B are in level 713 which may be near the bottom of the tree data structure 701 while node 705C is near the top of the tree structure as it is just below the root node 703. In one embodiment, a ranking criteria, such as a popularity weighting can be used more heavily for searches in nodes which are closer to the root node than searches which are not closer to the root node. For example, a popularity weighting can be weighted more in search results when search results for node 705C are provided, while search results for node 713B will use ranking criteria in which the popularity scores are weighted lower for purposes of ranking results. In effect, the weight for a certain ranking criteria varies upon the position of the node within the tree and this can provide certain desirable results. For example, searches higher up in the tree can give more generic results while searches lower down in the tree can give more specific results based upon the words in the search queries specific to the specific node. That is, more weight is given to the words in the actual search query derived from the node than from popularity scores or user ranking scores or other authority signals, such as the authority signals shown in the data source 751 in FIG. 7B. The popularity weighting can be a global parameter based across all of the apps in an app store and can be derived from the number of downloads of each app relative to the total downloads of all apps. So for example, an app such as “Angry Birds” may have a very high popularity score relative to most other apps. Another authority signal which can be used to provide ranking criteria can be the user ratings. In one embodiment, user ratings can be for all apps across the entire app store, so this rating can be a global parameter that is also applied to weight search results such that apps that get higher user ratings are sorted to be near the top of the list. Similarly, the popularity rating can be used to weight the search result so that more popular apps are rated near the top of the list. Another authority signal shown within the data source shown in FIG. 7B can be click data which can be derived on a per node basis and is a form of user feedback within a node. In one embodiment “click data” can be the number of times that users have selected a particular app for downloading within a group of apps ire the particular node. The “click data” ranking criteria can be also used within a particular node and it may be desirable to weight the click data more heavily than the popularity rating and the user ratings for a node that is lower in the tree than other nodes. In other words, the click data weights for ratings may be applied more heavily the lower the node is within the tree.

While the search queries can be based solely upon a particular selected node, in an alternative embodiment, the search query can be supplemented by text entered by a user who has also selected the particular node. This text can be conjoined with the rest of the search query using an AND operator to create a modified search query which is then used to search through a text database, such as an inverted index text database of text metadata from all of the apps in the app store. If a user does enter text in addition to selecting a category within a set of categories, then the search results can be further ranked based upon a match in the title or description of the text metadata for an app. For example, if the user types “Angry Birds” within the category games, then the game “Angry Birds” should appear as the first listed app in the search results because there is a match in title with text entered by the user within a selected category of games.

FIG. 8 shows an example of a system which can be used with one or more embodiments described herein. The system can include one or more servers 801 which can be operated by an app store operator as one or more web servers accessible through a network 811 to one or more client devices, such as client devices 815 and 817. The network 811 can be the Internet or local area network or a set of networks that are interconnected. Client devices 815 and 817 can be one or more of desktop computers, laptop computers, tablet computers, smartphones, etc. The one or more servers 801 can include executable computer program instructions which implement one or more app stores 805 through which one or more apps 803 can be purchased or otherwise obtained and downloaded to the one or more client devices, such as client devices 815 and 817 through the one or more networks 811. The app store 805 is operatively coupled to the dendrogram tree structure 807 which can be, for example, the tree data structure 201 or tree data structures 251. The dendrogram tree structure 807 can be stored in memory of one or more servers 801 and used in the methods described herein, such as the method shown in FIG. 5 or in FIG. 1. The one or more app stores 805 are also operatively coupled to the inverted index of text metadata 809 which can be any one of the text data structures described herein, such as the text data structure created in the method of FIG. 3 or the text data structure shown in FIG. 4 or the text data structure which is searched in operation 509 of FIG. 5. In one embodiment, the text metadata in data structure 809 can be all of the text metadata from all apps in the app store. It will be appreciated that in other embodiments, the one or more servers may host a digital media store, and the app store 805 may be replaced by or supplemented executable computer software which implements a digital media store through which users of client devices 815 and 817, for example, can download digital assets such as songs, movies, photos TV shows, magazines, books, etc. These digital assets or media can be stored in a storage system similar to the storage for apps 803 on the one or more servers 801. Moreover, a dendrogram tree structure similar to structure 807 can be created for the digital media or digital assets accessible through the digital media store. Similarly, an inverted index of text metadata for the digital media may be stored on the one or more servers 801 to provide for searching through that text data structure of the digital media. While this description describes embodiments in which the one or more methods are performed on one or more servers, it will be understood that other embodiments can perform these methods entirely locally on a single client device which does not interact with a server system, and in yet other additional embodiments these methods can be performed by both a client device and one or more servers which together perform the operations of these one or more methods.

In one embodiment, it may be beneficial to require that the elements of the search query which represent different levels of the tree data structure be proximal to each other (for example in the same sentence or paragraph) or be otherwise symantically or syntactically related. Similarly, the disjunction of terms representative of a given node in the tree data structure may be relevance weighted so as to better match the subject of the label of the node. In one embodiment it will be understood that the developer of the app can select the label assigned to a particular node in the tree data structure and thereby assign to the app a particular category or label for the app; in another embodiment, the app store operator may assign the main label or category to an app and further assign other categories to the app. The methods described herein can be performed to provide search results to users who are searching for apps in an on-line app store or who are searching for digital media in an on-line media store. In one embodiment, these users can use their client devices to display a user interface of an app store (or other type of on-line store) and display a user interface that allows a user to select one or more categories of apps in the app store, and these client devices can then transmit the selection of a category (and optionally search terms entered by the user) and receive the search results that were generated using one or more of the methods described herein.

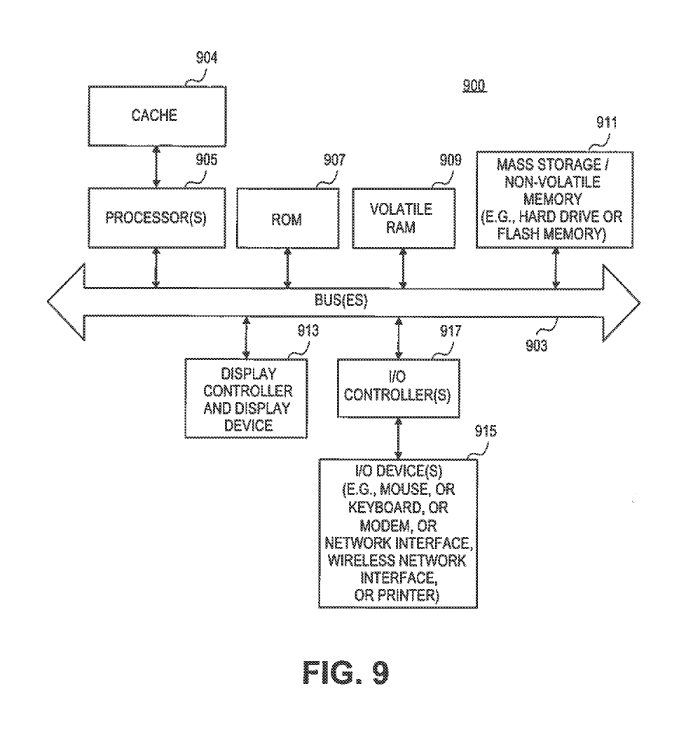

FIG. 9 shows one example of a data processing system, which may be used with any one of the embodiments described herein. Note that while FIG. 9 illustrates various components of a data processing system, it is not intended to represent any particular architecture or manner of interconnecting the components as such details are not germane to this description. The various embodiments described herein can be implemented with different types of data processing systems, including, for example, server systems, desktop computers, laptop computers, etc. It will also be appreciated that network computers, tablet computers, game devices, smartphones, consumer electronic devices and other data processing systems which have fewer components or perhaps more components may also be used to implement the one or more embodiments described herein.

As shown in FIG. 9, the computer system 900, which is a form of a data processing system, includes a bus 903 which is coupled to one or more processor(s) 905 and a ROM (Read Only Memory) 907 and volatile RAM 909 (e.g. DRAM) and a non-volatile memory 911. The one or more processors 905 are coupled to optional cache 904. The one or more processors 905 may retrieve stored computer program instructions from one or more of the memories 907, 909 and 911 and execute the instructions to perform one or more of the methods described above. These memories represent examples of machine readable non-transitory storage media that can store or contain computer program instructions which when executed cause a data processing system to perform the one or more methods described herein. The bus 903 interconnects these various components together and also interconnects these components 905, 907, 909 and 911 to a display controller and display device 913 and to peripheral devices such as input/output (I/O) devices 915 which may be one or more of mice, touch screens, touch pads, touch sensitive input devices, keyboards, modems, network interfaces, printers and other devices which are well known in the art. Typically, the input/output devices 915 are coupled to the system through input/output controllers 917. The volatile RAM (Random Access Memory) 909 is typically implemented as dynamic RAM (DRAM) which requires power continually in order to refresh or maintain the data in the memory. The system 900 can be used to implement the one or more servers 801 in FIG. 8, and a system like system 900 can be used to implement the one or more client devices 815 and 817 in FIG. 8.

The mass storage 911 is typically a magnetic hard drive or a magnetic optical drive or an optical drive or a DVD RAM or a flash memory or a hydrid storage (which includes a magnetic hard drive and flash memory) or other types of memory system which maintain data (e.g., large amounts of data) even after power is removed from the system. Typically the mass storage 911 will also be a random access memory although this is not required. While FIG. 9 shows that the mass storage 911 is a local device coupled directly to the rest of the components in the data processing system, it will be appreciated that one or more embodiments may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A machine implemented method comprising:
storing a representation of nodes in a dendrogram tree data structure, the nodes representing categories of items;
receiving a user's selection that specifies one of the nodes in the dendrogram tree data structure;
constructing a search query based on the specified node, the search query being specific for the specified node relative to search queries for other nodes in the dendrogram tree data structure;
searching through a data structure, which contains metadata of the items in the categories, using the search query to generate a list of items matching the search query for the specified node;
transmitting at least a portion of the list of items to the user.

2. The method as in claim 1, wherein the method further comprises:
creating ranking criteria for the specified node, the ranking criteria being different for the specified node relative to ranking criteria for other nodes in the dendrogram tree data structure;
ranking the list of items using the ranking criteria to generate a ranked list of items;
transmitting the ranked list of items to the user.

3. The method as in claim 2 wherein the items include apps stored in an app store and wherein the data structure includes an inverted index containing the metadata of the apps stored in the app stored.

4. The method as in claim 3 wherein the search query is constructed and cached before receiving the user's selection that specifies one of the nodes.

5. The method as in claim 3 wherein the searching through the data structure is performed after the user's selection and in response to the user's selection.

6. The method as in claim 3 wherein the search query is constructed in response to receiving the user's selection that specifies one of the nodes.

7. The method as in claim 3 wherein the dendrogram tree data structure has a single root node with no parent nodes and has multiple nodes that each have a single parent node and multiple child nodes.

8. The method as in claim 2 wherein the items include digital media stored in a media store and wherein the data structure includes an index containing the metadata of the digital media and wherein the digital media include one or more of: (a) songs; (b) movies; (c) photos; (d) TV shows; (e) magazines; or (f) books.

9. The method as in claim 2, wherein the method further comprises:
updating the dendrogram tree data structure to change or add or remove categories; and wherein the categories include the types of items.

10. The method as in claim 2 wherein the ranking criteria for a node near the root of the dendrogram tree data structure includes an authority signal that is weighted more heavily than a weighted authority signal in ranking criteria for a node not near the root and wherein the authority signal comprises one or more of: user ranking scores; popularity scores; or data representing user interactions.

11. The method as in claim 2 wherein the search query includes a category of the specified node conjoined with the category of each ancestor node up toward the root of the dendrogram tree data structure.

12. A non-transitory machine readable storage medium storing executable instructions which when executed by a data processing system cause the system to perform a method comprising:
storing a representation of nodes in a dendrogram tree data structure, the nodes representing categories of items;
receiving a user's selection that specifies one of the nodes in the dendrogram tree data structure;
constructing a search query based on the specified node, the search query being specific for the specified node relative to search queries for other nodes in the dendrogram tree data structure;
searching through a data structure, which contains metadata of the items in the categories, using the search query to generate a list of items matching the search gum for the specified node;
transmitting at least a portion of the list of items to the user.

13. The medium as in claim 12, wherein the method further comprises:
creating ranking criteria for the specified node, the ranking criteria being different for the specified node relative to ranking criteria for other nodes in the dendrogram tree data structure;
ranking the list of items using the ranking criteria to generate a ranked list of items;
transmitting the ranked list of items to the user.

14. The medium as in claim 13 wherein the items include apps stored in an app store and wherein the data structure includes an inverted index containing the metadata of the apps stored in the app stored.

15. The medium as in claim 14 wherein the search query is constructed and cached before receiving the user's selection that specifies one of the nodes.

16. The medium as in claim 14 wherein the searching through the data structure is performed after the user's selection and in response to the user's selection.

17. The medium as in claim 14 wherein the search query is constructed in response to receiving the user's selection that specifies one of the nodes.

18. The medium as in claim 14 wherein the dendrogram tree data structure has a single root node with no parent nodes and has multiple nodes that each have a single parent node and multiple child nodes.

19. The medium as in claim 13 wherein the items include digital media stored in a media store and wherein the data structure includes an index containing the metadata of the digital media and wherein the digital media include one or more of (a) songs; (b) movies; (c) photos; (d) TV shows; (e) magazines; or (f) books.

20. The medium as in claim 13, wherein the method further comprises:
updating the dendrogram tree data structure to change or add or remove categories; and wherein the categories include the types of items.

21. The medium as in claim 13 wherein the ranking criteria for a node near the root of the dendrogram tree data structure includes an authority signal that is weighted more heavily than a weighted authority signal in ranking criteria for a node not near the root and wherein the authority signal comprises one or more of: user ranking scores; popularity scores; or data representing user interactions.

22. The medium as in claim 13 wherein the search query includes a category of the specified node conjoined with the category of each ancestor node up toward the root of the dendrogram tree data structure.

23. A non-transitory machine readable storage medium storing executable instructions which when executed by a data processing system cause the system to perform a method comprising:
storing a representation of nodes in a dendrogram data structure;
creating data for one of the nodes by performing a search through a data structure of a set of documents.

24. The medium as in claim 23 wherein the search is through metadata in the documents, and the metadata describes items in categories represented by the nodes.

25. A non-transitory machine readable storage medium storing executable instructions which when executed by a data processing system cause the system to perform a method comprising:
displaying a user interface of an on-line store, the user interface comprising a plurality of selectable categories of items in the on-line store;
receiving a selection of one of the selectable categories and transmitting the selection to one or more servers;
receiving search results from the one or more servers, the search results obtained by searching through a data structure, which contains metadata of the items in the categories, using a search query to generate a list of items matching the search query for a specified node, wherein the specified node is specified by the selection of the one of the selectable categories, and wherein each of the plurality of selectable categories is represented by a node in a dendrogram tree data structure, and wherein the search query is constructed based on the specified node.
